(19) United States
(12) Patent Application Publication
(10) Pub. No.: US 2003/0062736 A1
(43) Pub. Date: Apr. 3, 2003

(54) Secure cover for open cargo space

(76) Inventors: Izaak A. Ulert, Houston, TX (US); Heinrich Lang, The Woodlands, TX (US)

Correspondence Address: Valerie K. Friedrich, 1422 Chestnut Springs, Houston, TX, 77062, US

(21) Appl. No.: 09/965,895

(22) Filed: Sep. 28, 2001

(51) Int. Cl. B60P 7/04

(52) U.S. Cl. 296/24.1; 296/37.16

(57) ABSTRACT

A secure cover for the open cargo area of a vehicle having a retractable and extendable screen attached to a tubular drum. The ends of the screen are held in an interlocking manner within guides running horizontally along the sidewalls of an open cargo area. The secure cover, when extended, prevents access to the cargo area of the vehicle by persons in the passenger compartment of the vehicle so as to provide a secure cargo area similar to the trunk space of other vehicles.

### FIELD OF THE INVENTION

This invention relates to a cover for the open cargo space found in certain vehicles, such as wagons and sport utility vehicles, which, when deployed, provides a secure location which cannot be accessed through the passenger compartment of the vehicle.

### BACKGROUND OF THE INVENTION

Many popular vehicles produced in recent years, such as hatchbacks and sport utility vehicles (“SUVs”), do not have separate and separately secured trunk space. Such vehicles typically have a storage area located behind the rear seating area but such storage area is usually open to the view of persons located outside the vehicle. Consequently, owners of such vehicles hesitate to carry valuable or enticing cargo in the storage area of the vehicle for fear that a passerby may be motivated to break into the vehicle and steal the cargo. One solution to this problem was the development of cargo space shields which provide a flexible and retractable cover over the cargo area to block the view of the cargo area. Such cargo space shields, however, while blocking the view, provide no real security to the contents of the cargo space. That is, if a thief breaks into the passenger compartment of a vehicle, the cargo space is readily accessed from the interior of the vehicle. Consequently, there is a need for a means for securing the open cargo area of vehicles such that such open cargo areas cannot be accessed by one located in the interior passenger compartment of the vehicle.

### SUMMARY OF THE INVENTION

The present invention provides a secure cargo area cover which prevents access from the interior of the vehicle into the cargo area and which may be retracted when not needed. The secure cargo area cover is comprised of a tambour-like shield which is rolled onto a drum when not in use. The device of the present invention may be deployed and disengaged without the use of any key other than the vehicle key and may be installed as either a piece of original equipment manufacture or as a post production improvement.

### BRIEF DESCRIPTION OF THE DRAWINGS

FIG. 1 is a perspective view of the secure cargo area cover in the engaged position. The usual components of a vehicle are shown by dashed lines.

FIG. 2 is a side view of the secure cargo area cover in the engaged position.

FIG. 3 is a perspective view of a first embodiment of an end of a single tambour of the screen of the secure cargo area cover.

FIGS. 4a is an end view of the permanent member of a first embodiment of a guide of the secure cargo area cover.

FIG. 4b is an end view of the removable member of a first embodiment of a guide of the secure cargo area cover.

FIG. 4c is an end view of the removable member partly in place with the permanent member of a first embodiment of a guide of the secure cargo area cover.

FIG. 4d is an end view of a first embodiment of a guide of the secure cargo area cover.

FIG. 4e is a perspective view of the permanent member of a first embodiment of a guide of the secure cargo area cover.

FIG. 5 is an end view of the removable member of a first embodiment of a guide with a tambour secured in the guide.

FIG. 6 is a perspective view of a first means of attaching stationary shaft 7 to sidewalls 101.

FIG.7 is a perspective view of an alternative means of attaching stationary shaft 7 onto sidewalls 101.

FIG. 8A is a top view of a first means for securing a back seat for use with the secure cargo area cover.

FIG. 8B is a side view of a first means for securing a back seat for use with the secure cargo area cover.

FIG. 9 is a perspective view of a second means for securing a back seat for use with the secure cargo area cover.

FIG. 10 is a side partial cross section view of a second embodiment of the secure cargo area cover with the screen extended.

FIG. 11 is a side partial cross section view showing a partial winding of screen 1 onto rotating drum 8.

FIG. 12 is a perspective view of screen 1 showing the interlinking of tambours.

FIG. 13 is a perspective view of an alternative embodiment of enclosure 9.

### DETAILED DESCRIPTION OF THE INVENTION

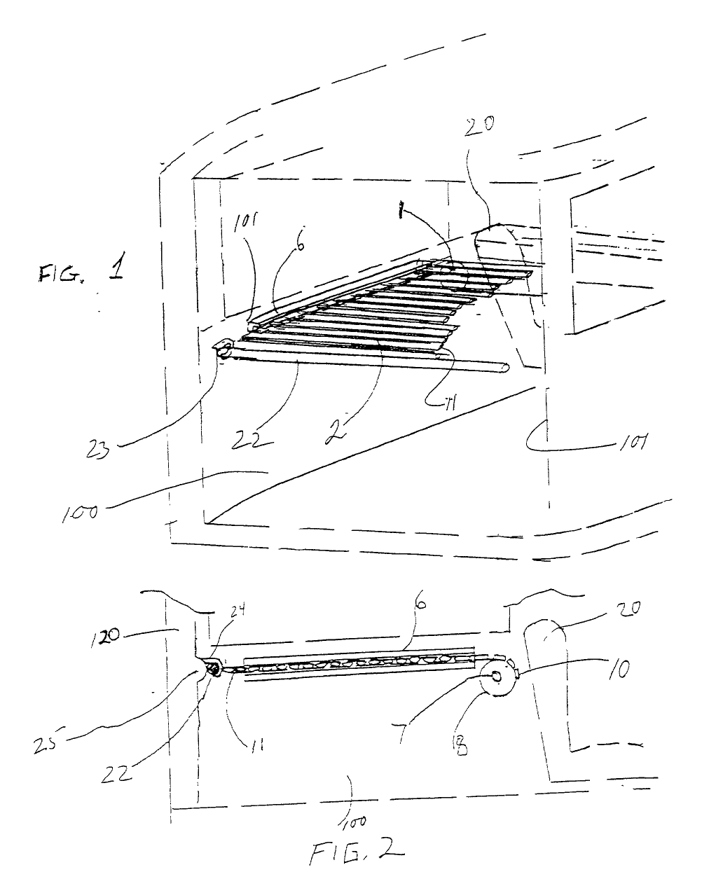

Referring first to FIGS. 1 and 2, the secure cargo area cover is a multi-component device having a screen 1, with an attached edge 10, a retractable edge 11 and made of a plurality of tambours, or interlocking slats, 2 so that screen 1 is flexible and may be rolled onto a drum or roller when not in use. In the preferred embodiment, screen 1 is wound around a rotating drum 8 which rotates around a stationary shaft 7. Attached end 10 is fixedly attached lengthwise along the length of rotating drum 8. Rotating drum 8 may be spring loaded onto stationary shaft 7 so that screen 1 is automatically wound onto rotating drum 8 unless a force is applied to retractable end 11 to prevent such automatic winding. It will be understood that rotating drum 8 and stationary shaft 7 may be placed within an enclosure 9, shown in FIG. 13, so as to guard against accidentally catching of the tambours on any nearby item during the re-winding process. When not in use, screen 1 would then also be held within such enclosure 9. Enclosure 9 could be of any of a number of shapes, such as tubular or box-like. It will be understood that enclosure 9 must have a lengthwise extending opening 70 so as to permit screen 1 to enter and exit enclosure 9. Referring now to FIG. 6, stationary shaft 7 has both a right end 14 and a left end 15. Right and left ends 14 and 15 are attached to right and left sidewalls respectively at a point behind the rearmost seat 20 of the vehicle. It will be understood that stationary shaft 7 is placed sufficiently close to rearmost seat 20 so as to prevent a person being able to reach between seat 20 and drum 8 and/or enclosure 9 when the cover is in its engaged position. It will be further understood that shaft 7 is placed at a sufficient distance from seat 20 so as to allow space for screen 1 to roll onto drum 8 when not being used. Stationary shaft 7 may be attached to the interior end walls of an enclosure 9, in which case, each end of enclosure 9 is attached to a sidewall of the open cargo space 100. Alternatively, stationary shaft 7 may extend through enclosure 9 and attach directly to sidewalls 101.

Tambours 2 may be made of any substantially rigid material, such as metal, fiberglass or plastic. When being used, the screen 1 is extended across the open cargo space 100 of a vehicle with the tambours 2 extending lengthwise across the open cargo space 100. Each of the ends of the tambours 2 are held in place along each of the sidewalls 101 of the open cargo space 100 within guides 6, as shown in FIG. 1.

Referring now to FIG. 2, the cover of the present invention is shown in its engaged position. Along the retractable edge 11 a final member 22 is attached. In the preferred embodiment, member 22 is a rigid rod of a slightly longer length than tambours 2. Right and left hooks 23 and 24 (not shown) are attached at the rearmost edge of open cargo space 100 on right and left sidewalls, respectively. To secure the screen 1 in place, a right end of member 22 is placed within right hook 23 and a left end of member 22 is placed within left hook 24. As seen in FIGS. 1 and 2, hooks 23 and 24 are placed such that a solid edge is facing upward. Once member 22 is secured within hooks 23 and 24, any slack in screen 1 is tightened by the spring tension between rotating drum 8 and stationary shaft 7. To further secure screen 1, a protrusion 25 on the back door 120 of the vehicle may be used to abut final member 22 when such back door 120 is closed. It will be understood that protrusion 25 may extend the width of back door 120 or alternatively, that protrusion 25 may consist of two or more discrete protrusions located across from each of hooks 23 and 24..

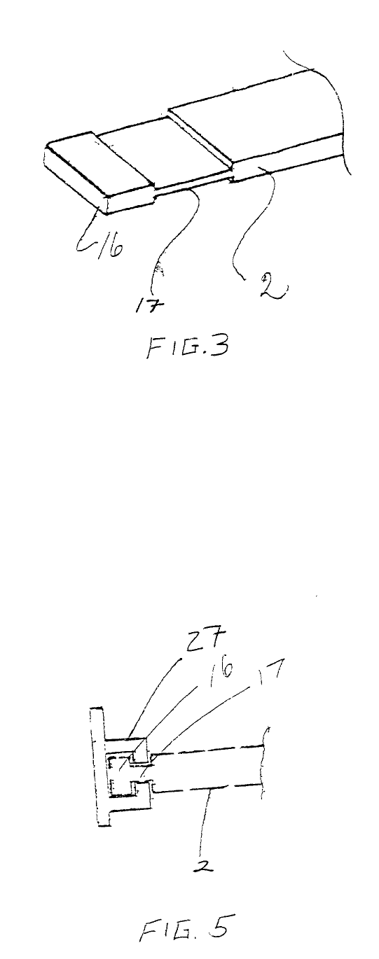

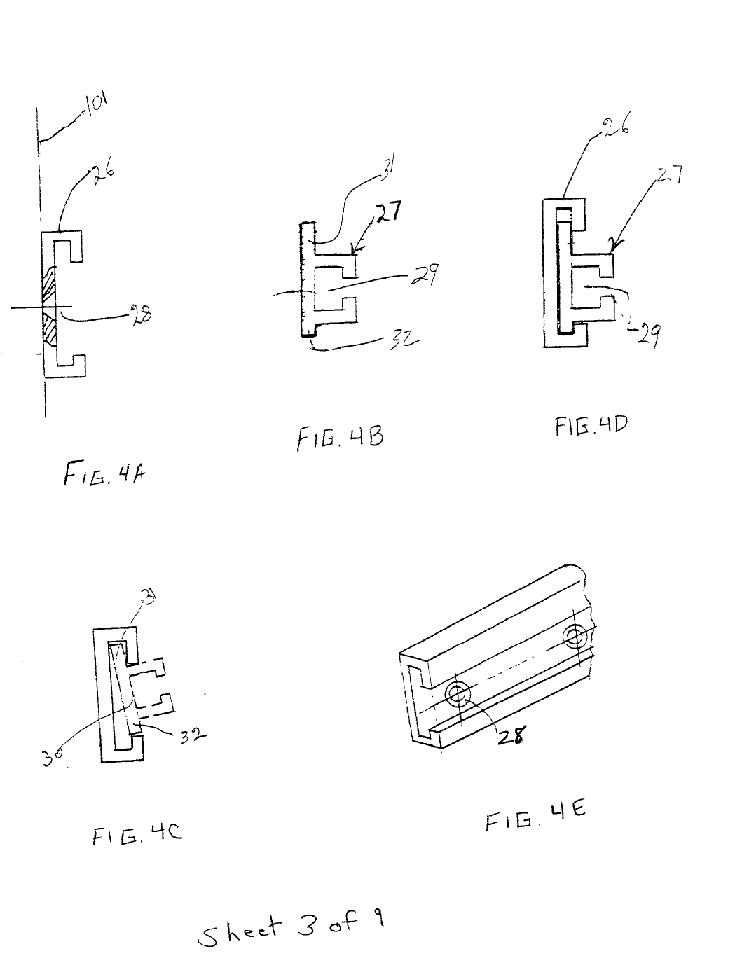

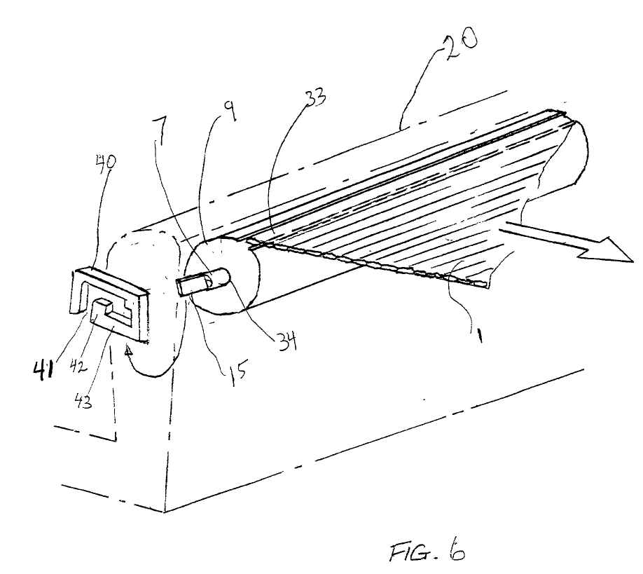

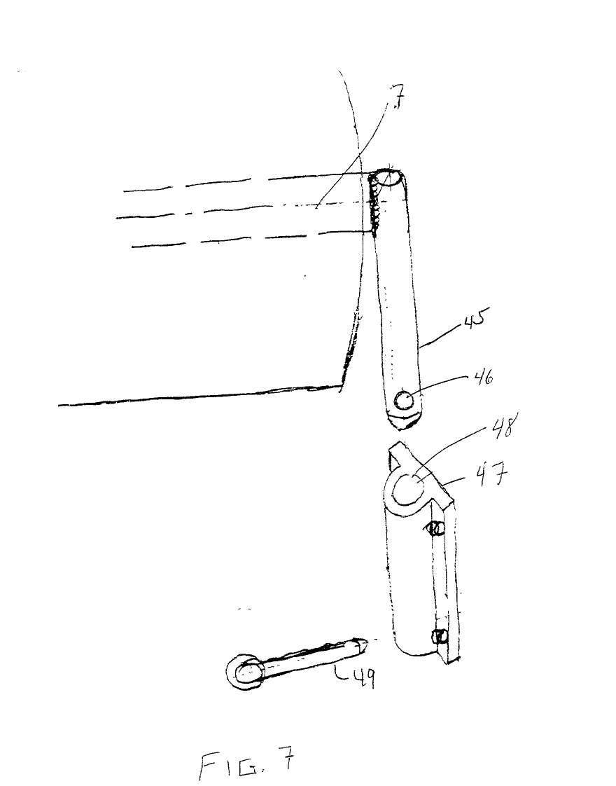

Referring now to FIG. 3, a detail of a first embodiment of tambours 2 is shown. Proximate to each end of each tambour 2 is a depression 17. Depression 17 forms a knob 16 at each end of each tambour 2. Knob 16 and depression 16 secure screen 1 within guides 6 as discussed in more detail with reference to FIGS. 4 and 5.

Referring now to FIG. 4, a first embodiment of guide 6 is shown. Such first embodiment is made of two members, a permanent member 26 and a removable member 27. Permanent member 26 is semi-permanently or permanently attached along the length of a sidewall 101 of the vehicle using any of a number of known methods, such as screwing or gluing. In FIGS. 4a and 4e, permanent member 26 is shown with openings to accommodate screws 28. Permanent member 26 is a substantially C-shaped channel made of any of a number of substantially rigid materials, such as metal, fiberglass and plastic. FIG. 4a shows permanent member 26 attached to sidewall 101 with a screw 28 passing through the rear wall 29 of permanent member 26 and into sidewall 101. Referring now to FIG. 4b, removable member 27 is made of a substantially C-shaped channel 29. Extending upward from a back wall member 30 of removable member 27 is a first vertical extension 31 and extending downward from back wall member 30 is a second vertical extension 32. The size and shape of removable member 27, including channel 29 and extensions 31 and 32 are such as to allow removable member 27 to removably interlock into permanent member 26 as shown in FIGS. 4c and 4d. Referring now to FIG. 5, channel 29 is sized and shaped to receive in an interlocking manner knob 16 of tambour 2. It will be understood that knob 16 and therefore, channel 29 may have other shapes, such as a round knob and circular channel, so long as the shapes are interlocking so as to prevent tambour 2 from being pulled transversely out of guide 6. In the preferred embodiment, knob 16 is of the same size and shape as tambour 2 for manufacturing ease. It will be understood that an end portion of channel 29 located proximate to drum 8 may be outwardly flared so as to allow easy engagement of tambour ends 16 within channel 29.

In the preferred embodiment of the secure cargo area cover, an enclosure 9 is used to cover rotating drum 8 and stationary shaft 7 (and screen 1 when not extended). Referring to FIG. 13, it is shown that enclosure 9 may be of either a tubular or box-like shape in the preferred embodiments. It will be understood that a variety of shapes may be used for enclosure 9 depending upon the configuration of the area in which it is to be placed. Referring now to FIG. 6, enclosure 9 is a tubular structure having a slot 33 through which screen 1 passes, and right and left openings, 34 and 35 (not shown), in right and left faces, 36 and 37 (not shown), respectively. In the preferred embodiment, the ends of stationary shaft 7 extend through openings 34 and 35. Each end of stationary shaft 7 attaches to a sidewall 101 of the vehicle. Preferably, the ends of stationary shaft 7 are attached to the sidewalls in a removable manner. Referring to FIG. 6, one means for removably securing stationary shaft 7 to the sidewalls is shown. Shaft bracket 40 is attached to sidewall 101 (not shown). Shaft bracket 40 has a channel opening 41 pointing downward and located proximate to seat 20, a lip portion 42 and a horizontal portion 43. When an end of stationary shaft 7 is passed through channel opening 41 and over lip portion 42, the end comes to rest on horizontal portion 43. When both ends of stationary shaft 7 are engaged in shaft brackets, the weight of rotating drum 8, stationary shaft 7 and enclosure 9 hold the secure cargo area cover in place with the ends of stationary shaft 7 resting on horizontal portions 43. Because screen 1 is extended when the secure cargo area cover is in use, stationary shaft 7 and rotating drum 8 cannot be pulled backward so as to release stationary shaft 7 from bracket 40.

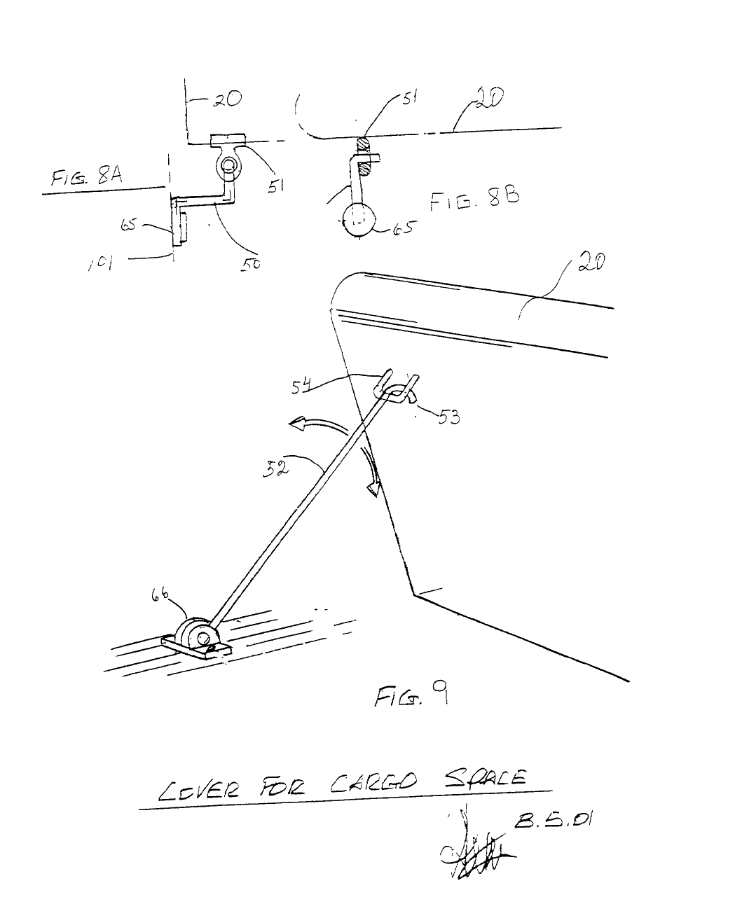

Referring now to FIG. 7, an alternative means of attaching stationary shaft 7 onto sidewalls 101 is shown. As seen in FIG. 7, a downward facing rod 45 may be fixedly attached to each end of stationary shaft 7. Near the bottom portion of rod 45 is an opening 46. Rod 45 is slid into a rod bracket 47, which is attached to sidewall 101. Rod bracket 47 has a vertically oriented tubular opening 48 to receive rod 45. After rod 45 is placed through opening 48 it is locked into place with a locking pin 49 engaged within opening 46. It will be understood that once screen 1 is engaged, rod bracket 47 and locking pin 49 will be within the secured cargo area and therefore, cannot be disengaged by an individual in the passenger compartment of the vehicle.

It will be understood that a variety of means may be used to permanently or removably attach stationary shaft 7 between and to the sidewalls of the vehicle cargo area. It will be further understood that the same results may be achieved by fixedly mounting stationary shaft 7 within enclosure 9 and using either removable or permanent means to attach the two ends of enclosure 9 to the sidewalls 101.

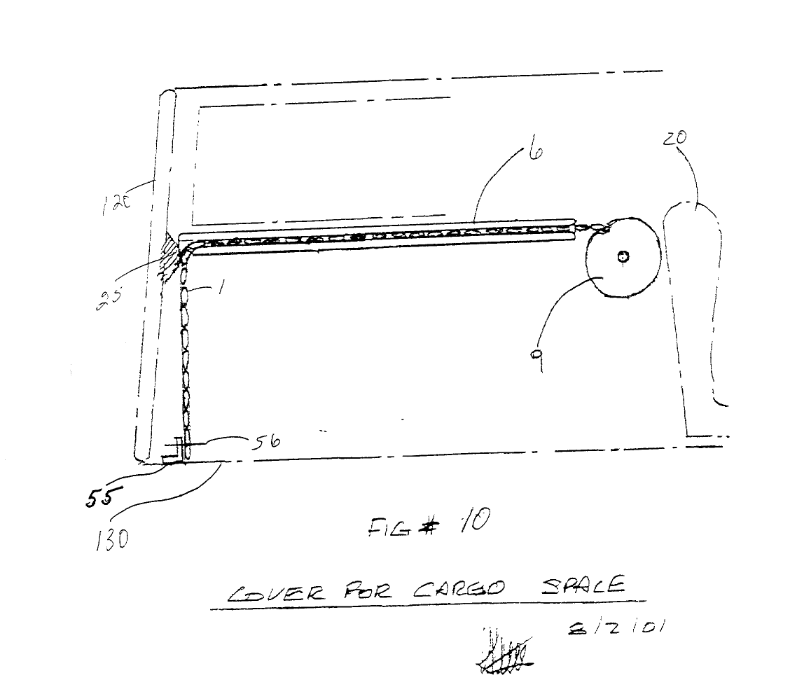

In certain models of vehicles, the seat 20 may be able to be folded forward by individuals located inside the passenger compartment of the vehicle. In such models, it would be necessary to secure seat 20 in its upright position when the secure cargo area cover is being used so as to prevent access into the cargo area by an individual located in the passenger compartment. Referring to FIG. 8A and 8B, one method of securing seat 20 is shown. In this method a hook 50 is pivotally attached to sidewall 101 using pivot bracket 65 such that hook 50 is below screen 1 when screen 1 is extended. An open ring 51 is attached to the back surface of seat 20 at a location such that hook 50 may be engaged into ring 51. FIG. 9 shows an alternative method for locking seat 20 in place. In this alternative embodiment, one end of a brace 52 is pivotally attached, by means of a pivot bracket 66, to the floor of the cargo area. Brace 52 has a hook 53 on its other end. An open ring or latch 54 is attached to the back surface of seat 20. When the secure cargo area cover is to be used, brace 52 is pivoted forward so that hook 53 engages latch 54. It will be understood that the methods of securing seat 20 discussed herein are exemplary and that a number of other means for preventing the forward folding of seat 20 may alternatively be used.

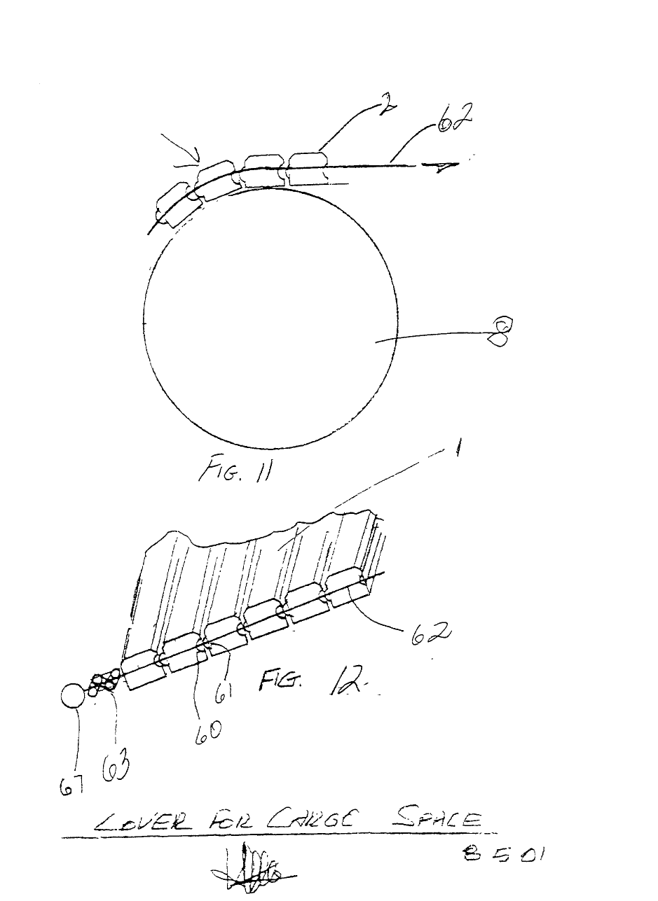

In an alternative embodiment of the secure cargo area cover, and referring to FIG. 10, the retractable edge 11 of screen 1 is extended across the top of the cargo area through guides 6 and then downward, substantially perpendicularly to the rear door 120 and is finally secured to the floor 130 of the cargo area 100. Any number of known bracketing or attaching means 57 may be used to temporarily attach edge 11 to floor 130. In FIG. 10, a 90-degree angle bracket 55 and locking pin 56 are shown as such attaching means. Protrusions 25 are used to abut screen 1 at that point where screen 1 turns downward. Vertical guides (not shown) substantially like horizontal guides 6 may be used to hold the downward portion of screen 1. Such vertical guides may be permanently or semi-permanently attached; in the case of permanently attached guides, only a single permanent portion is needed. It will be understood that the channel at a top end of the vertical guides may be outwardly flared so as to allow easy engagement of tambour ends 16 within the channel. As shown in FIG. 10, the attaching means is inaccessible to an individual in the passenger area of the vehicle when the secure cargo area cover is engaged and therefore, there is no need to provide keyed or otherwise security attaching means, unless such is desired or elected.

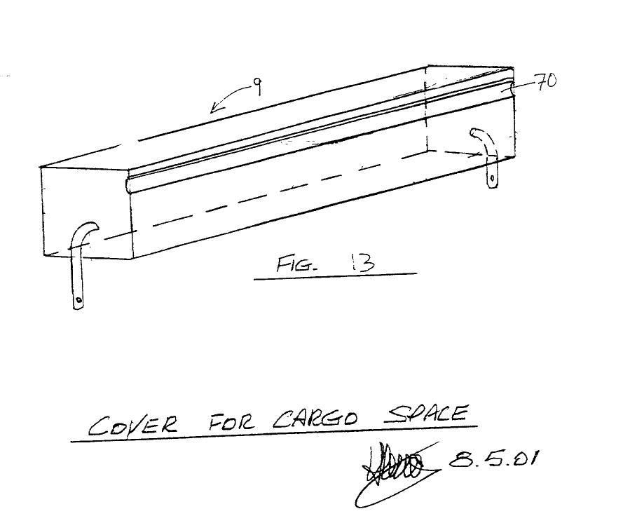

To form a screen 1, each of tambours 2 must be linked in some manner to each other and must be formed so as to slidably interlock when rolled onto rotating drum 8. Referring to FIGS. 11 and 12, the configuration and attachment of tambours 2 of the preferred embodiment is shown. As shown in FIG. 11 each tambour has a tongue and groove portion with the grooved portion 60 of one tambour aligned with the tongue portion 61 of the adjacent tambour. The tambours 2 are attached together to form the screen 1 by use of two or more cables 62 passing through each of tambours 2 and secured at the first and last tambours of the screen 1.

As can be seen from FIG. 11, when screen 1 is rolled onto drum 8, there is a slightly greater separation between tambours 2 than when the screen 1 is extended. Therefore, the length of cables 62 is such that when screen 1 is extended there is some slack in cables 62. Springs 63 surround cables 62 and abut against and between final member 22 (not shown in FIG. 11) and a retaining knob 67. It will be understood that when screen 1 is extended, springs 63 are flexed so that each of tambours 2 are pressed close to the proximate tambours thereby causing screen 1 to be rigid. When screen 1 is rolled onto drum 8, the slack in cables 62 is used and springs 63 are compressed.

It will be understood that a number of alternative methods for attaching tambours could be used as an alternative to cables 62. For example, in rolltop desks, it is common to attach the tambours to each other by gluing the tambours onto a flexible backing material, such as heavyweight canvas.

We claim:

1. A secure cover for an open cargo area of a vehicle having right and left sidewalls, a cargo area floor, a seat and a back door comprising:
a retractable screen comprised of a plurality of tambours and having an attached end, a retractable end, a right edge and a left edge;
said tambours having right and left edges and a knob at each said right and left edge;
a stationary shaft having a right end and a left end;
a rotating drum concentrically surrounding said stationary shaft and across which said attached end of said screen is fixedly attached;
means to attach said right end of said stationary shaft to said right sidewall and to attach said left end of said stationary shaft to said left sidewall, said
means located near or below the upper edge of said back seat;
a right guide attached to said right sidewall;
a left guide attached to said left sidewall;
said right and left guides each comprising a knob channel sized and shaped such that said knobs of said tambours interlock with said knob channel;
bracket means to removably attach said retractable edge of said screen to said back door of said vehicle.

2. The secure cover for open cargo area of claim 1 further comprising:
one or more protrusions extending forward from said back door at a location to abut said retractable edge of said screen.

3. The secure cover for open cargo area of claim 1 further comprising:
means to secure said back seat such that said back seat cannot be folded forward.

4. The secure cover for open cargo area of claim 1 further comprising:
an enclosure surrounding said rotating drum, having a transverse opening through which said screen passes, right and left faces and openings in each of said right and left faces through which said stationary shaft extends outside of said enclosure.

5. The secure cover for open cargo area of claim 3 wherein said means to secure said back seat comprises:
an open ring protruding rearwardly from a back surface of said back seat and located below a horizontal plane formed by said screen when said screen is pulled forward into said guides; and
a hook pivotally mounted on said sidewall, said hook located and sized to interlock with said open ring.

6. The secure cover for open cargo area of claim 3 wherein said means to secure said back seat comprises:
an open ring protruding rearwardly from a back surface of said back seat and located below a horizontal plane formed by said screen when said screen is pulled forward into said guides
a brace pivotally attached at a first end of said brace to said floor of said open cargo area and having a hook at a second end of said brace, said hook sized and said brace located such that said hook interlocks with said open ring.

7. The secure cover for open cargo area of claim 4 wherein said enclosure is tubular in shape.

8. The secure cover for open cargo area of claim 4 wherein said enclosure is box-like in shape.

9. The secure cover for open cargo area of claim 1 wherein said tambours interlock using a tongue and groove configuration.

10. The secure cover for open cargo area of claim 1 further comprising:
two or more cables passing laterally through each of said tambours thereby connecting said tambours to each other.

11. The secure cover for open cargo area of claim 1 wherein said guide comprises:
a permanent member of a substantially C-shaped design and said permanent member attached fixedly to said sidewall;
a removable member, said removable member having first and second vertical extensions extending upwardly and downwardly, respectively from said knob channel.

12. A secure cover for an open cargo area of a vehicle having right and left sidewalls, a cargo area floor, a seat and a back door comprising:
a retractable screen comprised of a plurality of tambours and having an attached end, a retractable end, a right edge and a left edge;
said tambours having right and left edges and a knob at each said right and left edge;
a stationary shaft having a right end and a left end;
a rotating drum concentrically surrounding said stationary shaft and across which said attached end of said screen is fixedly attached;
an enclosure surrounding and enclosing said stationary shaft and said rotating drum and having a transverse opening and having a right face and a left face;
means to attach said right face of said enclosure to said right sidewall and to attach said left face of said enclosure to said left sidewall, said means located near or below the upper edge of said back seat;
a right guide attached to said right sidewall;
a left guide attached to said left sidewall;
said right and left guides each comprising a knob channel sized and shaped such that said knobs of said tambours interlock with said knob channel;
bracket means to removably attach said retractable edge of said screen to said back door of said vehicle.

13. A secure cover for an open cargo area of a vehicle having right and left sidewalls, a cargo area floor, a seat and a back door comprising:
a retractable screen comprised of a plurality of tambours and having an attached end, a retractable end, a right edge and a left edge;
said tambours having right and left edges and a knob at each said right and left edge;
a stationary shaft having a right end and a left end;
a rotating drum concentrically surrounding said stationary shaft and across which said attached end of said screen is fixedly attached;
an enclosure surrounding and enclosing said stationary shaft and said rotating drum and having a transverse opening and having a right face and a left face;
means to attach said right face of said enclosure to said right sidewall and to attach said left face of said enclosure to said left sidewall, said means located near or below the upper edge of said back seat;
a right guide attached to said right sidewall;
a left guide attached to said left sidewall;
said right and left guides each comprising a knob channel sized and shaped such that said knobs of said tambours interlock with said knob channel;
means to removably attach said retractable edge of said screen to said floor of said open cargo area..

14. A secure cover for an open cargo area of a vehicle having right and left sidewalls, a cargo area floor, a seat and a back door comprising:
a retractable screen comprised of a plurality of tambours and having an attached end, a retractable end, a right edge and a left edge;
said tambours having right and left edges and a knob at each said right and left edge;
a stationary shaft having a right end and a left end;
a rotating drum concentrically surrounding said stationary shaft and across which said attached end of said screen is fixedly attached;
means to attach said right end of said stationary shaft to said right sidewall and to attach said left end of said stationary shaft to said left sidewall, said means located near or below the upper edge of said back seat;
a right guide attached to said right sidewall;
a left guide attached to said left sidewall;
said right and left guides each comprising a knob channel sized and shaped such that said knobs of said tambours interlock with said knob channel;
means to removably attach said retractable edge of said screen to said floor of said open cargo area.
